(19) United States
(12) Patent Application Publication
(10) Pub. No.: US 2002/0072902 A1
(43) Pub. Date: Jun. 13, 2002

(54) Adoptive storage of audio signals

(75) Inventors: Christian Georg Gerlach, Ditzingen (DE); Ivan Bourmeyster, Paris (FR)

Correspondence Address: SUGHRUE MION, PLLC, 2100 Pennsylvania Avenue, NW, Washington, DC, 20037-3213, US

(73) Assignee: ALCATEL

(21) Appl. No.: 09/994,888

(22) Filed: Nov. 28, 2001

(30) Foreign Application Priority Data
Nov. 29, 2000 (DE) 100 59 362.3

(51) Int. Cl. G10L 21/00; G10L 19/02

(52) U.S. Cl. 704/229

(57) ABSTRACT

A process for storing audio signals, in particular speech messages, comprises the following process steps: (a) digitalization of incoming audio signals; (b) storage of the digitalized audio signals in a memory in areas with a first memory size and bit rate; (c) monitoring of the occupancy of the memory; (d) determination of the current occupancy rate, in particular full occupancy of the memory; (e) reduction of the memory size and bit rate of the already stored audio signals to a second, smaller value as soon as a predetermined occupancy rate of the memory is reached and (f) occupation of the memory space released in the memory at least in part by newly incoming audio signals.

### BACKGROUND OF THE INVENTION

The invention relates to a process for storing audio signals, in particular speech messages. The invention further relates to a device comprising a means for digitalizing incoming audio signals, a memory means for the storage thereof, as well as a control device, computer programs and in particular suitable server units, signalling equipment, processor modules and programmable gate array modules for supporting and implementing a process of this kind.

The invention is based on a priority application DE 100 59 362.3 which is hereby incorporated by reference.

### SUMMARY OF THE INVENTION

The recording of audio- and in particular speech signals is currently performed digitally using audio- or speech coders and a digital memory. Prior to the actual storage, the digitalized audio signals are generally compressed. In this way irrelevant and redundant information is removed from the data stream. Due to real-time conditions and other non-ideal circumstances, such as for example limited computing capacity or uncertainty about the properties of the audio signal source, this type of signal processing is not loss-free. The audio signals or speech data retrieved and decoded after storage are almost always reduced in quality compared to the original. The quality of the stored audio signals or coded speech messages is always approximately inversely proportional to the compression factor: the stronger the compression, the poorer the subsequent quality of the reproduced signal. Conversely, with a high quality of the stored signals, an extremely extensive memory space is required.

The quality reduction of the signals is thus obviously dependent upon the bit rote of the compressed data stream which for example will range between 4 and 12 kbit/s. In contrast to tape storage, the digital information can currently be stored in high-speed RAMs or other digital memory means of different types which, although reduced in size, permit random access.

Since the source information is normally non-stationary (silence, speech, voiced and voiceless sections) the bit rate should naturally be as variable as possible. On account of the special channel—in the memory means—with asynchronous properties, coding with a variable bit rate is possible and customary. The fact that the source is non-stationary can thereby easily be utilized, which is finally reflected in the average bit rate of a code. This average is normally obtained via “medium-length” speech samples.

Standard devices with digital audio- or speech recording have a limited but generally random access memory which for example can fulfil the function of an answering machine.

The textbook “SPEECH CODING AND SYNTHESIS” by W. B. Kleijn, 2nd Edition 1998, p. 5 to 7 has disclosed the storage of incoming speech signals with variable bit rate where, in the case of increased memory occupancy, newly incoming signals are to be stored with a lower bit rate than the signals already stored in the memory. The latter are not changed however, and neither is new memory area released by this procedure.

A disadvantage of this known process is that it leads to a non-uniform quality of the consecutively stored signals, the newer signals having a poorer quality than the older, already stored signals. Therefore the available total memory space can in no way be optimally utilized since in particular the older stored signals occupy too large a memory area. Furthermore with this process a quality reduction can take place even in the case of newer signals, which might not in fact be necessary unless there were following, even newer signals. U.S. Pat. No. 5,546,395 has disclosed a process for dynamically selecting the compression rate of speech messages which are digitally transmitted across a telephone line. The compression rate is dependent upon the bandwidth of the telecommunications channel and upon the speed of the transmission. The compression factor is consequently changed as a function of these two extreme factors. The known process is suitable only for signal transmission and not however for signal storage, in particular not for an optimised occupancy of existing memory space in a memory means.

As soon as the coding algorithm has been selected together with the above mentioned, corresponding, average bit rate, in the known process the speech quality and the maximum storage capacity are generally determined and fixed once and for all. However the maximum memory length is an extremely important specification when comparing competitive market products.

During standard use it is frequently observed that the memory means fills up only slowly and very often remains empty over a long time period and over a large area before the stored messages are retrieved and erased, whereby the memory is emptied again. This means that for every conceivable situation it would be better to store the information with a higher bit rate in order to provide the possibility of a higher reproduction quality and to compress the information only to the extent necessary for the storage of new data.

At the same time it is to be possible to record a speech signal of arbitrary length up to its maximum length without an interruption occurring. The best possible reproduction quality is thus to be achieved for any (standard) length.

Therefore the object of the present invention is to further develop a process of the type described in the introduction with the simplest possible means such that the available memory space can be optimally utilized, where a quality reduction of signals is to take place only when this is actually necessary to be able to store newer signals, where the degree of a quality reduction is to be as small as possible, and where the newest incoming signals are to undergo no quality reduction compared to the already stored, older signals.

In accordance with the invention, this object is achieved in an equally surprisingly simple and effective manner by the following process steps:

(a) digitalization of incoming audio signals;

(b) storage of the digitalized audio signals in a memory in areas having a first memory size and bit rate;

(c) monitoring of the occupancy of the memory;

(d) determination of the current occupancy rate, in particular full occupancy of the memory;

(e) reduction of the memory size and bit rate for the already stored audio signals to a second, smaller value as soon as a predetermined occupancy rate of the memory is reached; and

(f) occupation of the memory space released in the memory at least in part by newly incoming audio signals.

The process according to the invention also functions in the case of source-dependent, variable-rate coding of the incoming audio signals.

A digital audio- or speech recording is achieved with a limited but random access memory, where the reproduction quality is considerably improved while retaining a continuously guaranteeable maximum memory time by better utilization of the fact that the memory fills only slowly and possibly by utilization of the standard user behavior, such as for example pauses in use. In particular, interruption-free conversation recording is also facilitated by the process according to the invention.

If pauses in use so permit, virtually loss-free, quality-retaining recoding of the stored signals a(n) can additionally take place. In this way the computing capacity required for the operation can be transposed to pause times and is free for other operations during receiving times. Furthermore the memory space thus obtained is immediately available to the next incoming signal packet.

It is also possible to select between speech coders with a low bit rate and low quality or those with a higher quality but also a higher bit rate. In the former case there is a long maximum recording time, whereas in the other cases the recording time is shorter.

As already mentioned, a maximum memory time corresponding to the lowest bit rate can be guaranteed by the process according to the invention in every instance of use.

In the recording of a signal, the memory means fills only slowly and therefore is fully utilized only rarely. When the memory is empty, recording with a high bit rate and a correspondingly high reproduction quality firstly takes place until the memory has filled to a specific degree. Then the memory size of the already stored audio signals is reduced so that a predetermined occupancy rate of the memory is not exceeded.

A particularly preferred variant of the process according to the invention is that in which in step (b) the newly incoming audio signals are stored in the memory with the same bit rate as those signals already or still present in the memory. In this way a uniform bit rate of all the stored audio signals can be ensured.

Another advantageous alternative process variant is that in which in step (b) the newly incoming audio signals are stored in the memory with a higher bit rate than those signals already or still present. A better utilization of the available memory space with a preference for newer incoming signals can be achieved with this process variant.

In an advantageous further development of this process variant, in step (e) the memory size and bit rate for already stored audio signals a(n) are reduced as a function of the age or dwell time of the relevant audio signals a(n) in the memory. This facilitates a differentiated treatment of the already stored messages, where the criterion for overwriting is not necessarily the sequence of entry, which would be unsuitable for example in the case of inputs occurring in short succession, but is the (possibly even “impressed”) age of the message and thus its (inverse) urgency and relevance.

Additionally or alternatively, in another preferred process variant, the reduction of the memory size in step (e) takes place by recoding the already stored audio signals with a lower bit rate than in the case of their input in step (b). This process variant can be executed particularly simply and efficiently. An optimal utilization of the available memory capacity as a function of the current data quantity can be facilitated. Furthermore the recoding can also take place non-causally with reference to the time direction of the already stored signals.

An advantageous further development of this process variant according to the invention is that in which, prior to the recoding, the audio signals are analyzed in respect of their information content and the analyzed parameters of the audio signals are used for the recoding independently of their time position. In this way a “rearwardly directed” statistical dependency, i.e. a highly non-causal approach, can be employed. This enables the setting of the interpolation points in the time curve of the audio signal, which is to be stored and later reproduced with interpolation, also to take place only when the entire signal is known.

Another alternative process variant which is particularly preferred is characterized in that the incoming audio signals are coded in hierarchically layered manner in 7 levels of information blocks of different importance, and that the reduction of the memory size in step (e) takes place by the successive omission of the respective lowest level or levels of the hierarchically layered information blocks. No computation outlay whatsoever is required for this process variant as no recoding of already present, stored audio signals occurs. It is merely necessary for memory areas to be overwritten in accordance with a specified, predetermined pattern.

Hierarchical coding per se is known for example from U.S. Pat. No. 5,815,097 which however does not describe the hierarchical storage of data and in which the hierarchical overwriting of received audio signals in a memory medium is not disclosed even by way of suggestion.

In a preferred further development of the above mentioned process variant, the layering of the different information blocks takes place in accordance with at least one predeterminable importance criterion. This results in numerous possibilities of use of the process according to the invention.

For example the middle frequency of a frequency- or speech band contained in the audio signal can be selected as importance criterion, so that if necessary the upper frequencies of the audio- or speech signal can be omitted in step (e).

Alternatively or additionally, a mean error, preferably a mean quadratic error of a parametric representation of the audio signal, in particular of a multi-stage vector quantization, can be selected as importance criterion, where if necessary in step (e) one or more higher stages of the parametric representation can be disregarded.

Again alternatively or additionally, speech pauses can be recognised in the audio signals and arranged hierarchically in a lower stage.

It is also possible to detect background noises in the audio signals and to arrange these hierarchically in a lower stage.

This process variant can advantageously be further developed such that if necessary in step (e) natural background noises currently present in the audio signals are replaced by artificial, in particular synthetic noise signals (=comfort noise).

Finally in another process variant, the value of 100% of the memory space available in the memory, thus absolute full occupancy, is preset as the memory occupancy rate from which a reduction in memory size and bit rate takes place in step (e). In this way a particularly good utilization of the properties of the process according to the invention can be achieved; in particular a quality reduction of already stored signals does not take place until this is actually unavoidable for reasons of memory space.

The scope of the present invention also includes a server unit, a processor module and a gate array module for supporting the above described process according to the invention and a computer program for the execution of the process. The process can be implemented either as a hardware circuit or in the form of a computer program. Software programming for high-power DSPs, for example in modern mobile telephones, is currently preferred as new insights and additional functions can more easily be implemented by changing the software on an existing hardware basis. However processes can also be implemented as hardware modules, for example in IP- or TC terminals or conventional telephone apparatus.

The scope of the present invention also includes a device with the features referred to in the introduction, where the memory means comprises areas of a first memory size for storing the digitalized audio signals, where the control device comprises means for detecting an occupancy of all the areas of the memory means, where when it is determined that a preset occupancy rate of the areas of the memory means, in particular full occupancy, has been achieved, the digitalization means can effect a compression of the already stored audio signals from the first memory size to a second smaller memory size, and where the control device can store newly incoming audio signals in released memory space in the memory means.

Further advantages of the invention will become apparent from the description and the drawing. Also the features described above and those to be described in the following can be used in accordance with the invention either individually or jointly in any combinations. The illustrated and described embodiments are not to be understood as a final specification but rather are to serve by way of example for the description of the invention.

### BRIEF DESCRIPTION OF THE DRAWINGS

The invention is illustrated in the drawing and will be explained in detail in the form of exemplary embodiments. In the drawing:

FIG. 1 is a diagram for the digital coding of audio signals, in particular speech messages, storage on a memory means, and reproduction;

FIG. 2 is a schematic illustration of hierarchical memory occupancy;

FIG. 3 illustrates a parallel coding of newly incoming audio signals s(n) and of already stored audio signals a(n);

FIG. 4 is a diagram of the hierarchical coding with the associated data streams and

FIG. 5 is a diagram of the overwriting, according to the invention, of low hierarchical stages in the memory means with newly incoming audio signals.

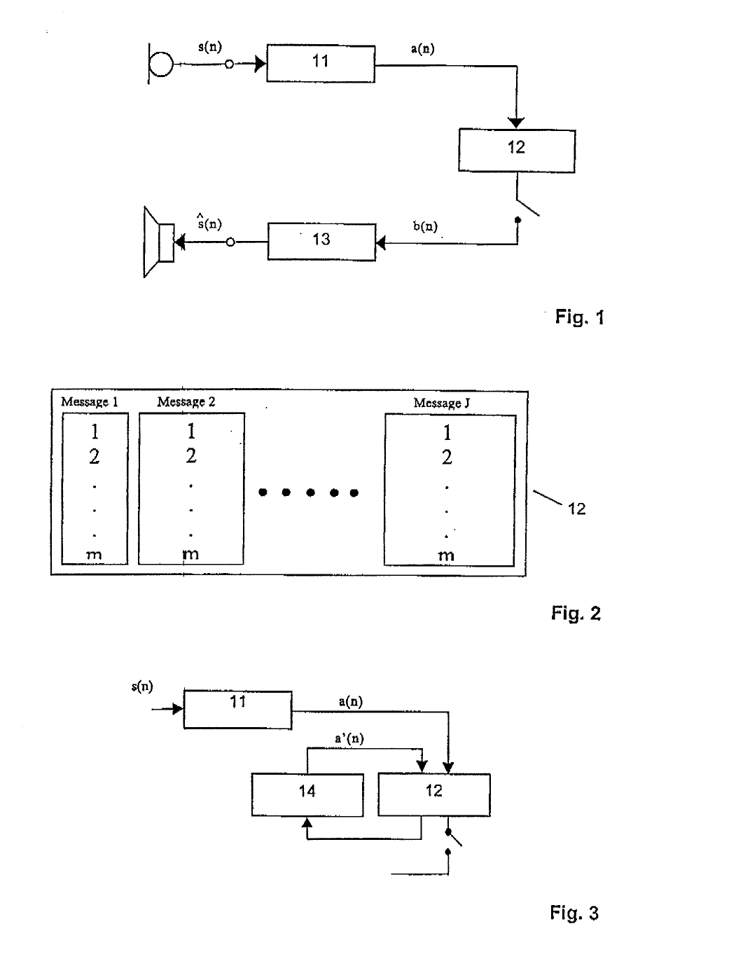

For an audio connection, in particular a telecommunications connection, indicated by a microphone symbol and loudspeaker symbol, FIG. 1 schematically illustrates how an audio signal s(n) is digitalized and compressed in a coding device 11 into a digitalized and compressed signal a(n), for example with a bit rate of between 4 and 12 kibt/s, and then stored in a memory means 12. From here audio data b(n) can be retrieved and reconstructed in a decoder 13 and fed as audio signal _(n) to a loudspeaker.

To achieve a higher average quality in the reconstruction of the retrieved and decoded audio signals, while simultaneously retaining a specific guaranteed maximum memory capacity even in the case of a newly incoming audio data stream, in accordance with an embodiment of the present invention it is proposed that the compressed audio data stored in the memory means 12 are overwritten in a specified manner:

To begin with, the audio signals are stored in the initially empty memory means with a high bit rate (and correspondingly high reproduction quality) until the memory is full, as indicated in FIG. 2, when a total of J messages or packets of audio signals have been input.

Then the stored signals are coded with a lower bit rate and correspondingly higher compression, and a part of the information already stored in the memory means 12 is overwritten.

There are several options for enabling the already stored audio signals to remain reconstructible in a reasonable manner:

FIG. 3 illustrates an embodiment of the process according to the invention wherein a type of “flying” compression of the audio data is performed. Here, in the coding device 11, as illustrated in FIG. 1, the incoming new data s(n) are digitalized and compressed and fed as data stream a(n) to the memory means 12. In parallel thereto, the compressed audio data already stored in the memory means 12 are further compressed in a codec 14 and fed as data stream a′(n) to the memory means 12. This second compression of already stored information provides sufficient free memory space in the memory means 12 so that the incoming audio data stream a(n) emanating from the parallel-operating coding device 11 can likewise be stored on the memory means 12.

However, this requires a specific computing capacity for the two parallel coding operations.

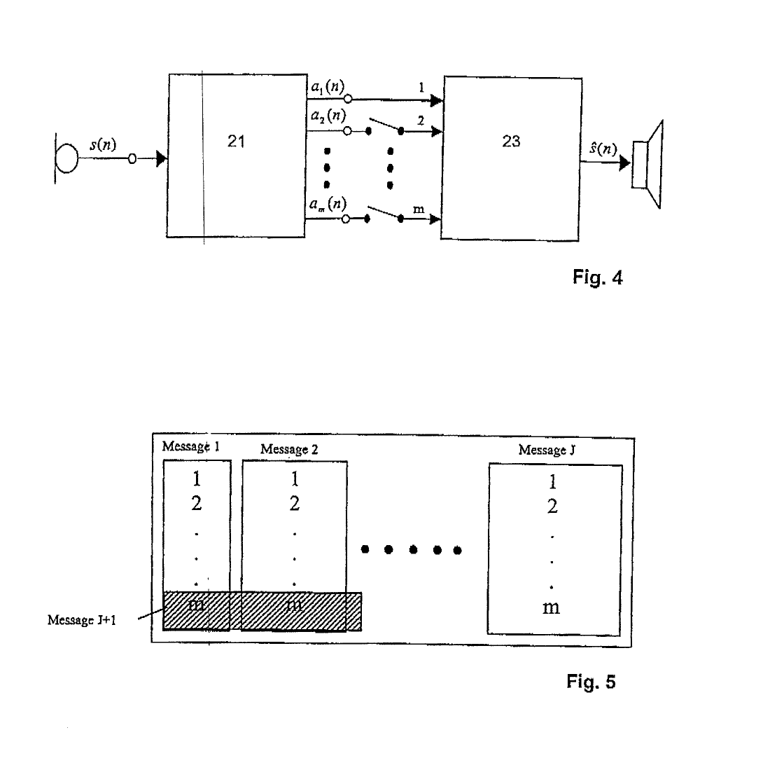

In the case of another audio data processing option according to the present invention indicated in FIG. 4, this computing capacity can be saved.

Here the incoming audio signals s(n) are firstly digitalized and compressed in a hierarchical coding device 21 in accordance with a hierarchical coding scheme. The audio signals are coded in such manner that they give rise to a hierarchically arranged data stream as indicated in FIG. 4. Although this has been omitted from FIG. 4 for simplicity, this data stream is fed, correspondingly hierarchically layered in a quantity of compressed data streams a₁(n), a₂(n), . . . , aₘ(n), to a memory unit in which the compressed data are stored in a corresponding hierarchical manner. From here they can be retrieved again when required, assembled to form an audio signal _(n) in a likewise hierarchically organised decoder 23 and fed to a loudspeaker.

The core information, which is designated by the data stream a,(n) in FIG. 4, forms the layer 1 which assumes the uppermost position in the hierarchical layering of the data. These compressed audio data can be used to reconstruct the incoming audio signal s(n) with the lowest possible accuracy. This corresponds to the lowest possible bit rate and highest possible compression stage.

If additional layers 2, 3 are added to the layer 1, the reconstructed signal is improved in its quality. The use of all the layers up to the layer m results in the highest possible bit rate and thus the highest possible reproduction quality of the decoded signal. This situation corresponds to the high-rate coding which is employed at the start of an input storage of the incoming audio signal. The stored layers 1 to m for the different signal packets, such as are present in the memory means 12, are also shown in FIG. 2.

In this way it is possible to employ different strategies in order to release memory space in the memory means 12 when required using this hierarchical scheme of m layers. An important embodiment of the process according to the invention is illustrated in FIG. 5 where, in the event that the memory space in the memory means 12 is fully occupied by J stored audio signal packets, a newly incoming audio signal packet J+1 is overwritten onto the lowest layer m containing the “most unimportant” hierarchical data. Therefore only m−1 layers remain for the already stored audio signals 1 to J.

The newly incoming audio signal packet J+1 can be stored either with the same, now reduced bit rate, thus in m−1 layers, or with the originally maximum possible number of m hierarchical layers. In the former case all the signal packets stored in the memory means 12 would have the same uniform quality, whereas in the latter case newly incoming signal packets would have preference over older signal packets in respect of their quality on account of a higher number of hierarchical layers.

If the memory space obtained as a result of the above described procedure is used up again and the memory means 12 is full with stored audio signal packets, using the same scheme the data required for the reconstruction of the audio signals can be overwritten by overwriting the respective lowest hierarchical layers of the stored signal packets step by step, where the maximum possible signal quality in the reconstruction continuously decreases on the basis of the reducing hierarchical number of the respective overwritten data layer and thus the increasing “importance” for the reconstruction of the signal. In this way more and more new signals can be stored on the memory means 12 with the same memory capacity until finally only the uppermost hierarchical layer of previously stored audio signals remains. When this too is overwritten, the corresponding audio signal packets are completely erased from the memory means 12. In the case of an answering machine this can for example consist of a long, old speech message which is no longer of relevance. The compression factor for this lowest coding stage therefore defines the maximum memory capacity of the system which can be guaranteed under all circumstances.

It should be noted that the above described hierarchical overwriting mechanism entails a gradual reduction in the quality of the stored information, which however occurs only when this is necessary in order to accommodate new information in the limited memory medium.

This process would be ideal if it were possible to introduce an infinite number of hierarchical layers of arbitrary fineness. In practice of course this is not possible, and instead one is limited to a finite number of hierarchical layers. If the hierarchical coding were to operate precisely as efficiently as a non-hierarchical coding algorithm, the optimal realization of the above described object of the invention could be achieved. This realization would then be independent of the number of data packets to be stored and the algorithm would always ensure the optimal reconstruction quality for all the data packets at any time utilizing an existing limited memory capacity.

In the case of both of the above presented options for overwriting already occupied memory space, it should be noted that the mechanism according to the invention functions in every instance, even when there are no pause times in which the system is not used. This occurs in particular when, in the case of an answering machine, a conversation must be recorded and the length of time which the conversation to be recorded will occupy is initially unknown. In particular in this case the guaranteed maximum memory capacity of the system is to be as high as possible.

The overwriting technique according to the invention is also compatible with a process in which a variable bit rate is used as a function of the source. To remain with FIG. 5, the thickness of the hierarchical layers would then be variable and the time scale would vary between two limit values on passage through the memory 12.

A further improvement in the embodiments of the process according to the invention can be achieved if the latter are combined with offline-, non-real-time, non-causal recoding which is performed in rest pauses of the system when no new audio signals are incoming. In many cases the maximum utilizable memory capacity can thus be considerably increased as a function of the user behavior.

In the case of speech coding with a bit rate of between 12 and 4 kbit/s, the improvement due to the use of the process according to the invention can be quantified as follows: Coding with 12 kbit/s, for example using a GSM-EFR codec, virtually produces the quality of a ETSI “line transmission”. Coding with 4 or 3 kbit/s, as generally used in the case of a commercially available answering machine, produces a significantly lower quality, although the speech should remain sufficiently intelligible that the messages transmitted therein can be understood. It can thus be concluded that in the use of the technique according to the invention, the memory capacity can be increased by a factor of 2 to 3 depending upon the efficiency of the hierarchical coding scheme compared to the use of a codec with the highest bit rate.

The process according to the invention is also considerably more efficient than one which merely reduces the bit rate of the newly incoming audio signals during operation when the available memory space decreases.

Although the use of the above mentioned high-grade codec alone would result in a good speech quality for most expected situations and in this respect would meet the consumers' requirements, in practice this would not be possible because the guaranteed maximum memory capacity would be too greatly limited. However, with the process according to the present invention this is possible without the need to “sacrifice” the maximum memory capacity.

1. A process for storing audio signals, in particular speech messages, comprising the following process steps:
(a) digitalization of incoming audio signals s(n);
(b) storage of the digitalized audio signals a(n) in a memory in areas with a(n) first memory size and bit rate;
(c) monitoring of the occupancy of the memory;
(d) determination of the current occupancy rate, in particular full occupancy of the memory;
(e) reduction of the memory size and bit rate for the already stored audio signals a(n) to a second, smaller value as soon as a predetermined occupancy rate of the memory is reached and
(f) occupation of the memory space released in the memory at least in part by newly incoming audio signals s(n).

2. A process according to claim 1, wherein additionally a reduction of the memory size and bit rate of the already stored audio signals a(n) takes place in pauses in use when no newly incoming audio signals s(n) are received.

3. A process according to claim 1, wherein the reduction of the memory size in step (e) takes place by recoding the already stored audio signals a(n) with a lower bit rate than upon their input storage in step (b).

4. A process according to claim 1, wherein the incoming audio signals s(n) are coded, layered hierarchically, in levels of information blocks of different importance, and that the reduction in the memory size in step (e) takes place by successive omission of the respective lowest level or levels of the hierarchically layered information blocks.

5. A process according to claim 4, wherein the layering of the different information blocks takes place in accordance with at least one predeterminable importance criterion.

6. A process according to claim 5, wherein the middle frequency of a frequency band contained in the audio signal s(n) is selected as importance criterion, and that if necessary in step (e) the upper frequencies of the audio signal are omitted.

7. A process according to claim 5, wherein a mean error, preferably a mean quadratic error of a parametric representation of the audio signal s(n), in particular of a multi-stage vector quantization, is selected as importance criterion, and that if necessary in step (e) one or more higher stages of the parametric representation are disregarded.

8. A process according to claim 1, wherein 100% of the memory space available in the memory is preset as the occupancy rate of the memory from which a reduction of the memory size and bit rate takes place in step (e).

9. A device for storing audio signals, in particular speech messages, comprising a means for digitalizing incoming audio signals s(n), a memory means for the storage thereof, and a control device,
wherein the memory means comprises areas with a first memory size for storing the digitalized audio signals a(n),
wherein the control device comprises means for detecting an occupancy of all the areas of the memory means,
wherein when it is determined that a predetermined occupancy rate, in particular full occupancy, of the areas of the memory means is reached, the digitalization means can effect a compression of the already stored audio signals a(n) from the first memory size to a second, smaller memory size, and wherein the control device can store newly incoming audio signals s(n) in released memory space in the memory means.
